(19) United States
(12) Patent Application Publication
(10) Pub. No.: US 2015/0331779 A1
(43) Pub. Date: Nov. 19, 2015

(54) FRAMEWORK TO ACCOMMODATE TEST PLAN CHANGES WITHOUT AFFECTING OR INTERRUPTING TEST EXECUTION

(71) Applicant: Prabhu Subramaniam, Tamil Nadu (IN)

(72) Inventor: Prabhu Subramaniam, Tamil Nadu (IN)

(73) Assignee: UNISYS CORPORATION, Blue Bell, PA (US)

(21) Appl. No.: 14/307,624

(22) Filed: Jun. 18, 2014

(30) Foreign Application Priority Data
May 13, 2014 (IN) 1283/DEL/2014

(51) Int. Cl. G06F 11/36

(52) U.S. Cl. CPC G06F 11/368; G06F 11/3688

(57) ABSTRACT

In an exemplary computer implemented method for executing test scripts, a computer receives a test file having a set of one or more unique test script identifiers associated with a test script stored in a test script repository. The computer fetches a test script from the test script repository according to the test file, and stores the test script as a queued test script in a buffer memory. The computer provides instructions to a processor to execute the queued test script, and then receives results. The computer continuously monitors an action request queue configured to received action requests to change a test script or change the set of test script identifiers. The computer executes the action request before storing the next queued test script in the buffer memory.

### TECHNICAL FIELD

The present disclosure generally relates to testing software under development.

### BACKGROUND

Software developers often develop software code in distributed-computing environments where networked computing devices may have diverse operating systems, software modules, hardware, firmware, and among other variations between components that may adversely affect compatibility of the code being developed. Similarly, software developers must develop software compatible with a vast array of public and private-enterprise environments in which networked devices may have a diverse range of components adversely affecting compatibility. What is needed is a means for testing code being developed for software products to ensure that the code underlying the software will be compatible with various components of computing devices executing the code.

In many software development efforts, code development is often performed incrementally in the form of modular components of the software, sometimes referred to as classes, objects, or some other term of art depending upon the coding language being used that refers to its modules of code as representing a part of the whole software product. In this incremental development methodology, software code may be tested for efficient and effective performance as each smaller modular portion of the whole is completed. That is, smaller portions of code are often developed through testing before incorporating them into the whole. This incremental testing methodology contrasts with waiting to test the entire software application as whole, after completing the code in its entirety.

Often, developers utilize small chunks of code, so-called scripts, as mechanisms for testing incremental code portions of the whole software. Running automated scripts across multiple platforms typically requires significant effort to individually load each of the testing scripts into each specific system having a type of platform, to then execute the test script. Often, loading and running these scripts is manually done by a developer, as opposed to being automatically selected and executed by a system. This manual task of executing test scripts across multiple platforms can be time consuming. Moreover, in some case this manual task may also fail to find “bugs” in code portions of the software earlier in code development. This can also be time consuming when there are more scripts queued for execution across each platform.

Code may be developed and tested in software development environments, which are computer programs that present friendlier programming and testing interfaces for developers. Development environments may have frameworks that allow portions of code to execute without having a complete software product, thereby facilitating testing small modules of code before the software is completed. If a testing framework is not designed properly, then collating and disseminating test scripts and test script execution results can be tedious and cumbersome.

Often, loading and running these test scripts is done by a developer manually, as opposed to being automated by a system. Software developers would find it more efficient to be able to automate the retrieval and execution of the appropriate test scripts. Instead, developers typically manually select the scripts, load the script into a testing framework, trigger the test script, and then await the results for proper handling. This methodology can be time consuming, as it could take a significant amount of time to execute these tests. Automation testing would save time, and reduce requirements on manual resources.

An underlying problem with automating test script execution in a testing environment is addressing continual variance in an ever-changing development environment. A difficulty in script automation is that developers are not able to disturb the system in the middle of execution. Consequently, developers are unable to collect results and other data during execution. Moreover, developers are unable to make changes to the planned test scripts during execution. Ordinarily, an automated environment cannot handle changes to the scripts, changes to which scripts will execute, or able to supply developers with results, during execution.

What is needed is a way for developers to be able to gather script execution results while a batch of test scripts are being executed. What is needed is a way for gathering test script results executing in a batch, without affecting or interrupting remaining test scripts queued for execution. What is needed is a means for altering test scripts in a batch of test scripts planned for execution, without negatively impacting or otherwise interrupting the execution of the batch of test scripts. What is needed is a means for changing the test scripts that are planned to be executed and changing the priority in which the test scripts execute. What is needed is a way to update test scripts that are planned for execution, without interrupting the execution of the batch of test scripts. What is needed is a way to include additional test scripts to the batch of test scripts, and remove test scripts from the batch of test scripts, without interrupting the execution of the batch of test scripts.

### SUMMARY

Systems and methods disclosed herein describe a software development system executing test scripts in a testing framework that is capable of accommodating changes to a predetermined test script execution plan, where such changes can be accommodated without affecting or interrupting the ongoing testing. Systems and methods disclosed herein describe a software development system executing test scripts in a testing framework that is capable of updating and displaying results associated with executed test scripts without affecting or interrupting the ongoing testing. Other advantages may be presented from the systems and methods described herein.

In one embodiment, a computer implemented method for executing test scripts comprises receiving, by a computer, from a server a test file comprising a set of one or more unique test script identifiers, wherein each of the test script identifiers are associated with a test script stored in a test script repository; fetching, by the computer, a test script from the test script repository according to the test file; storing, by the computer, the test script as a queued test script in a buffer memory; updating, by the computer, a test script result record based on a result of executing the test script, wherein the result comprises a test script status indicating a pass when the queued test script is successfully executed and a fail when the queued test script is unsuccessfully executed; continuously monitoring, by the computer, an action request queue configured to receive and store one or more action requests indicating one or more changes to be made to the test file; responsive to identifying an action request in the action request queue: pausing, by the computer, execution of the set of test scripts in the test file until receiving an updated test file having the one or more changes of the request; and upon receiving the updated test file: updating, by the computer, the test script result record based on the result of executing a next test script in the test file.

In another embodiment, A software development system comprises a test script repository storing one or more test scripts, wherein each test script is associated with a unique test script identifier; a test file storing a set of test script identifiers, wherein each of the test script identifiers is associated with a test script priority; a driver computer comprising a processor configured to: fetch a queued test script from the test script repository using the test file, and then store the queued test script into a buffer memory; execute the queued test script and generate a test script result having a test script status, and then transmit the test script result to a web server; execute an action request to the web server when an action request is detected in an action request queue before fetching a next queued test script; and the web server comprising the action request queue and a web server processor, wherein the web server processor is configured to: generate the test file according to a request page, update the test file according to an action request, update a results page comprising one or more test script results in a human-readable format, and transmit action requests to the driver computer.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings. It is to be understood that both the foregoing general description and the following detailed description are exemplary and explanatory and are intended to provide further explanation of the invention as claimed

### BRIEF DESCRIPTION OF THE DRAWINGS

The accompanying drawings constitute a part of this specification and illustrate an embodiment of the invention and together with the specification, explain the invention.

FIG. 1 illustrates an exemplary system embodiment of a system for testing software code, which is capable of accommodating changes to software testing.

FIG. 2 illustrates a schematic illustration of an exemplary system embodiment.

FIG. 3 illustrates a flowchart of the logical steps performed by an exemplary method embodiment, in accordance with various systems, processes, software modules, and hardware as described herein.

### DETAILED DESCRIPTION

Reference will now be made in detail to several preferred embodiments, examples of which are illustrated in the accompanying drawings. The embodiments described herein are intended to be exemplary. One skilled in the art recognizes that numerous alternative components and embodiments may be substituted for the particular examples described herein and still fall within the scope of the invention.

It should be appreciated scripts may refer to software development tools, software code, and other machine-readable files prepared to effectively test certain aspects of a larger software development project. Although test scripts are particularly useful in larger object-oriented software development efforts, it should be appreciated that test scripts, code, software, processes, and modules are not intended to be limiting to large object-oriented software.

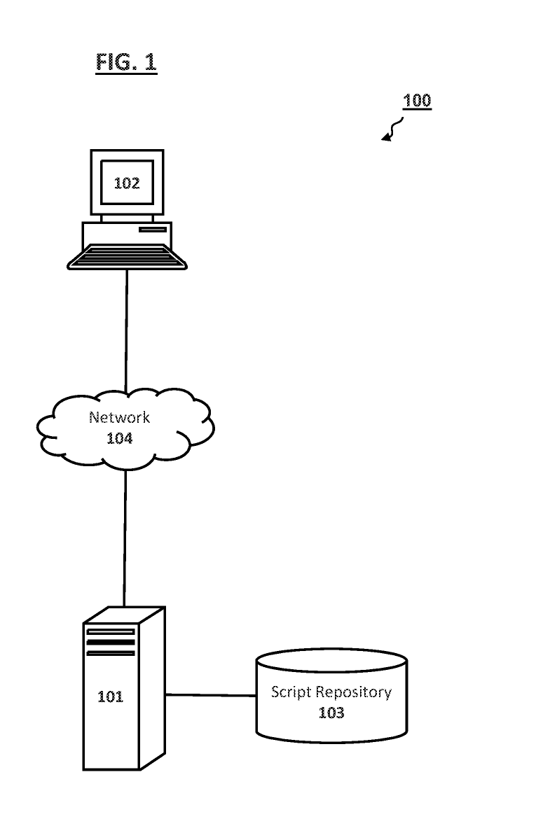

FIG. 1 shows an exemplary system embodiment for a software development system capable of accommodating changes to executing test scripts 100. The exemplary software development system 100 may comprise a web server 101 communicating over a network 104 with a computer 102 driving execution of test scripts; a script repository 103 may be connected to the web server 101. Developers responsible for administrating test script execution may interact with a developer user interface (“developer UI”) on the web server 101 allowing developers to select one or more test scripts 207 to execute for testing portions of code. The web server 101 may transmit a selection of test scripts to the driver computer 102, which may fetch and execute the selected test scripts from the test script repository 103.

A web server 101 may be a software products capable of hosting web-based services on a computing devices. Examples of web server 101 software products may include Microsoft Internet Information Services® and Apache Web Server®. The web server 101 may be housed on any physical computing device comprising a processor and memory for performing tasks and processes as described herein. The web server 101 may comprise more than one physical device such that the web server 101 operates in concert as a distributed computing system. The web server 101 may facilitate networked communication between the web server 101 and one or more remote computing devices, such as the driver computer 202. The web server 101 may comprise a developer UI for facilitating developer administration over test script execution. Using the developer UI hosted on the web server 101, the developer may select test scripts for testing the software under the development. The developer UI may comprise a request page for selecting tests scripts. The web server 101 may generate a test file according to the developer's selections from the request page. The test file contain a set of test script identifiers associated with the selected test scripts. The test file may be a non-transitory machine-readable storage medium capable of storing the selected set of test script identifiers.

A test script repository 103 may be any non-transitory machine-readable storage medium storing one or more test scripts for testing portions of code for the software under development. The script repository 103 may be a database storing test scripts using a database management system. The script repository 103 may be a text file containing test scripts. The script repository 103 may reside on the web server 102. The script repository 103 may be located on the driver computer 102. The script repository 103 may be on a distinct computing device having the requisite non-transitory memory.

A driver computer 102 may be any computing device comprising processors and non-transitory machine-readable storage medium such that the driver 102 is capable of performing various tasks and processes as described herein. It should be appreciated that in some embodiments various logical components of the driver computer 102 may reside on the driver computer 102, and that in some embodiments various components of the driver computer 102 may be found on distinct physical devices in networked communication with the driver computer 102.

In some embodiments, a driver computer 102 may receive a test file generated by a web server 101. The driver computer 102 may fetch test scripts stored in a test script repository 103 according to a listing of script identifiers listed in the test file. After fetching test scripts from the script repository 103 using the test file, the driver computer 102 may execute each of the test scripts and transmit results of executing test scripts, which may indicate the test scripts were successful (i.e., pass) or unsuccessful (i.e., fail).

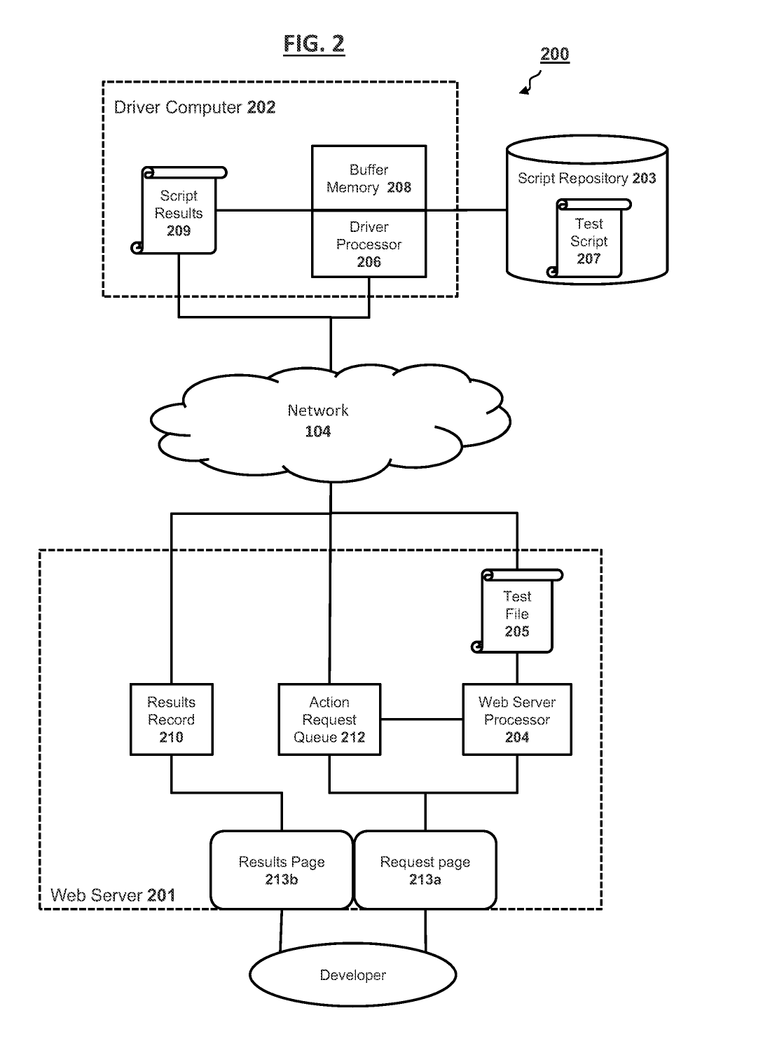

FIG. 2 shows a schematic illustration of an exemplary system for executing test scripts 200, showing the logical flow of test script execution. The exemplary system 200 shown by FIG. 2 comprises a web server 201, a driver computer 202, a test script repository 203, and web server 201, are each found on distinct devices. The script repository 203 may be the same device as the driver computer 202. The script repository 203 may be on the same device as the web server 201. The script repository 203 may be located on a distinct physical device such that the script, repository 203 may be in networked communication with the driver computer 202.

A web server 201 may be a software product hosting web-based services for presenting various displays (e.g., web pages) and performing various tasks as instructed by various web technologies and programming languages (e.g., PHP scripting, Javascript). The web server 201 may reside on any computing device comprising a processor capable of performing instructions issued by the web server 201 software to the processor; typically, this computing device may be a server computer. The web server 201 may comprise several logical components instructing operation of the hardware components of the underlying computing device hosting the web server 201.

In some embodiments, the logical components of the web server 201 may include a developer user interface (“developer UI”) 213; having at least a request page 213a and a results page 213b; a processor 204; a results record 210; and an action request queue 212. It should be appreciated that each of these logical components of the web server 201 may reside on a number of distinct devices. Each of the components of the web server 201 may reside on the same physical device. One or more logical components of the web server 201 may reside on distinct devices operating in concert in a distributed computing environment.

In some embodiments, a developer may use a developer UI 213 to select one or more test scripts 207 stored in a script repository 203 for testing portions of code related to a software product under development. The web server 201 may generate a test file 205 listing the selected test scripts 207, based on the selection received from the developer UI 213. Test scripts 207 stored in the script repository 203 may be associated with a script identifier (“script ID”), which may uniquely identify each of the associated test scripts 207. In such embodiments, the test file 205 may contain a listing of script IDs associated with the selected test scripts 207. The web server 201 may transmit the test file 205 to a driver computer 202 that then fetches the test scripts 207 from the script repository 203 according to the list found in the test file 205.

A driver computer 202 may be any computing device comprising a processor 206 and a non-transitory buffer memory 208, capable of executing instructions of various logical components in a manner described herein. It should be appreciated that the various hardware and software components of the driver computer 202 may reside on one or more devices, Each of the hardware and software components may reside on the driver computer 202. In some embodiments, software and hardware components of the driver computer 202 may reside on distinct physical devices operating in concert as a distributed computing environment. It should be appreciated that a web server 201 and a driver computer 202 may reside on the same computing device, and may reside on distinct computing devices.

In some embodiments, a web server 201 may comprise a developer UI 213, which may be an interface displayed on a monitor of the web server 201, facilitating the developer's administration over the system 200 and management over test script execution. That is, the web server 201 may instruct various aspects of the system 200 to perform processes and tasks based upon the developer's interactions with the developer UI 213. The developer UI 213 may comprise a request page 213a providing an interface for the developer to select test scripts and input other administrative commands. The developer UI may comprise a results page 213b, which may present test script execution results in a human-relatable format (e.g., written text, charts, images). It should be appreciated that in some embodiments, the request page 213a and the results page 2136 may be displayed on the same interface display.

In some embodiments, the developer UI 213 may be a series of web pages hosted by the web server 201. The developer UI 213 can be an interactive website comprising hyper-text markup language web pages (“HTML”) presented by a web browser over hypertext transfer protocol (“HTTP”). It should be appreciated that the developer UI 213 is not limited to HTML-based webpages. The developer UI 213 may be prepared using technology other than webpages, a website, HTML, hypertext transfer protocol (“HTTP”), and other web-based technology. It should be appreciated that the developer UI 213 may be generated using any capable programming language, as an alternative to HTML; or the developer UI 213 may be generated using a plurality of programming languages, in addition to HTML. For example, in some embodiments, the developer UI 213 may be a native software application built in C++, which may be compiled into an executable program file (exe) that may be installed onto the web server 201 to send and receive data streams, to and from various devices of the system 200.

Using a request page 213a, a developer may select one or more test scripts 207 to be executed for software testing. The request page 213a may instruct the processor 204 to generate a test file 205 according to the developer's selected test scripts 207. The test file 205 may contain a listing of test script identifiers that uniquely identity test scripts. The developer may also enter a priority level associated with the selected test scripts 207. The priority entries may determine the order in which the test scripts 207 are executed. The priority associated with each test script 207 may be reflected in the listing of script identifiers listed in the test file 205.

A test file 205 may be non-transitory machine-readable storage medium storing a listing of selected test scripts 207 a developer intends for execution. The test file 205 may be generated by a processor 204 based upon inputs from a request page 213a, The test file 205 may comprise a set of test script identifiers uniquely identifying the test scripts 207 selected by the developer, i.e., one test script identifier is uniquely associated with one test script 207. It should be appreciated that the test file 205 may be any non-transitory machine-readable storage medium capable of storing the listing of selected test scripts 207 and also capable of being queried as necessary. As an example, in some embodiments the test file 205 may be a text file storing the set of script identifiers for the selected test scripts and the associated execution priorities assigned to each of the test scripts 207. As another example, in some embodiments the test file 205 may be a spreadsheet listing the test script identifiers for the selected test scripts.

A test file 205, of some embodiments, may comprise a listing of information identifying test scripts 207 selected for execution by a developer. The test file 205 may also comprise a listing of execution priorities associated with the identifying information of the test scripts 207. As previously mentioned, in some embodiments, test scripts 207 that are stored in a. script repository 203 may each be uniquely identified according to a test script identifier. Each test script identifier may be a data sequence uniquely associated with a particular test script 207. In some embodiments, test script priorities may be values assigned by a developer to selected test scripts 207 to indicate the developer's desired order for executing the selected test scripts 207. In some embodiments, test script priorities may not be assigned as an explicit ordering for execution, instead the developer may set a preferred priority order based on various comparative characteristics associated with the test scripts, Examples of flexible ordering of test script priorities may include “the last test script 207 stored into the script repository 203 is the first test script 207 executed,” “the last test script 207 fetched from the script repository 203 is the first test script 207 to be executed,” or “the most efficiently accessible test script 207 is the first test script 207 to be executed,” It should be appreciated that any algorithmic schema may be applied to the test scripts 207 for dynamically determining the priority in which the test scripts 207 may be executed.

A test script repository 203 may be any non-transitory machine-readable storage medium capable of storing test scripts 207 and capable of being queried to return requested test scripts 207. The script repository 203 may be a database storing test scripts 207 according to a database management system. The script repository 203 may be a text file containing each of the test scripts 207. It should be appreciated that each of the component devices 201, 202, 203 of the system 200 may be distributed into any number of devices, or may be a single physical device. For example, as shown by the exemplary embodiment of FIG. 2, the test script repository 203, driver computer 202, and web server 201, are each found on distinct devices. However, in some embodiments, the test script repository 203 may reside on the driver computer 202 or on the same physical device as the web server 201, or both.

After a processor 204 of web server 201 generates a test file 205, the test file 205 may be transmitted to a driver computer 202. In the present embodiment shown by FIG. 2, the driver computer 202 and the web server 201 are shown as distinct physical devices. However, it should be appreciated that the driver computer 202, or components thereof, may be located with the web server 201 on the same physical device. A processor 206 of the driver computer 202 may receive a test file 205 listing test script identifiers for each of the test scripts selected for execution by a developer on a request page 213a. The processor 206 may fetch each of test scripts 207 from the test script repository 203 using the test file 205. In some embodiments, test scripts 207 may be fetched in the order of their respective priorities listed in the test file 205.

Once a processor 206 fetches test scripts 207 from a test script repository 203, the processor 206 may store the test scripts 207 into a non-transitory machine-readable storage medium buffer memory 208, which may be a queue for test scripts 207 awaiting execution by the processor 206. In some embodiments, test scripts 207 may be executed sequentially in the order in which each test script 207 queued into the buffer memory 208, i.e., first-in-first-out. The test scripts 207 are assigned a priority identifying the order in which the test scripts 207 are to be executed. The processor 206 may execute the test scripts 207 in order to determine a result, which may be a success, a failure, and an error. The processor 206 may then generate a listing of script results 209 based on the results of executing each respective test script 207. The buffer memory 208 may reside on distinct physical device. The processor 206 may transmit one or more test scripts 207 to the remote device comprising the buffer memory 208, which may then store the test scripts 207 into the buffer memory 208 where the test scripts 207 remain queued until execution. The processor 206 may then instruct the remote device to execute the queued test scripts stored in the buffer memory 208.

As previously mentioned, after a queued test script 207 is pulled from buffer memory 208 and executed by a processor 206, the processor 206 may determine a result for the test script 207 used for generating a test script result 209 associated with the test script 207. A test script result 209 may indicate a test script execution status (e.g., “pass”, “fail”, “error”) for a particular test script 207 associated with the script result 209. The test script result 209 may also contain an execution event log containing information relating to the execution of the associated test script 207. When the test script 207 fails, the test script results 209 may also include a snapshot of a display showing information related to the execution of the failed test script 207.

In some embodiments, one or more test script results 209 are stored in a non-transitory storage medium of a driver computer 202 before being transmitted over a network 104 to a web server 201. Once the web server 201 receives the test script results 209 from the driver computer 202, the web server 201 may store the test script results 209 into a results record 210, which may be a non-transitory machine-readable storage medium underlying the results page 213b interface of a developer UI 213. That is, the results record 210 may be any memory that is accessible to the web server 201 and is capable of providing test results 209 to a results page 213b for presentation in a human-relatable format. When a developer wishes to review an execution result for a particular test script 207, or for a set of test scripts 207, the results page 213b may generate an appropriate display by querying the results record 210.

In some cases, a developer may want to change test scripts 207 selected to be executed, i.e., adding test scripts, removing test scripts, or some combination. The developer may want to change the priority in which the test scripts 207 are executed. In some cases, the developer may wish to remove a test script, update the test script, and then add the updated test script back into the selection of test scripts. Some embodiments of a software development system 200 may accommodate one or more of the above mentioned changes, among others, to the selected test scripts planned for execution.

In some embodiments, a developer may implement changes to the test script execution plans by way of a request page 213a, which may send a request to the system 200 to recognize requested changes. Once the request is input into the request page 213a, the request is then stored in a request queue 212, which may be non-transitory machine-readable storage medium located on physical device accessible to the web server 201. In such embodiments, after a results record 210 is updated according to recent test script results 209, a processor 206 of the driver computer 202 may determine whether the request queue 212 contains a request that the developer has input via the request page 213a.

In cases in which a processor 206 of a driver computer 202 automatically detects a request being stored in a request queue 212, the processor 206 of the driver computer 202 halts test script execution to accommodate a developer's request for changes, which may require that a test file 205 be updated. The driver computer 202 can halt execution of test scripts until a web server 201 generates and transmits an updated test file 205 according to the request detected in the request queue 212. A developer may use a request page 213a to input requests for changing existing test script execution plans, which may be reflected in a test file 205. The request page 213a may generate the request and then store the request into the request queue 212. A processor 204 of the web server 201 may retrieve the request from the request queue 212 and then amend the test file 205 according to the requested changes. The processor 204 of the web server 201 may generate a new test file 205 based on the requested changes. The web server 201 may forward an updated test file 205, which reflects the requested changes from the developer, to the driver computer 202. The driver processor 206 may then fetch and execute test scripts 207 based on the updated test file 205.

In the event that the processor 206 of the driver computer 201 does not detect a request in a request queue 212, then the processor 206 may proceed with executing test scripts 207 in a test file 205. The processor 206 may next determine whether each test script 207 listed in a test file 205 has been executed. The processor may use unique test script identifiers listed by the test file 205 to determine whether each test script 207 was executed. If the processor 206 identifies an unexecuted test script 207 listed in the test file 205, then the processor 206 may fetch and execute the next test script 207 that is listed. The processor 206 may fetch the next test script 207 according to a priority assigned to each of the unexecuted test scripts 207.

If the processor 206 of the driver computer 202 does not detect a request in the request queue 212, and if the processor 206 does not identify an unexecuted test script 207 listed in the test file 205, then each of the test scripts 207 requested by the developer have been executed. in some embodiments, data related to test script execution results stored in a results record 210 may be displayed onto a results page 213b in a human-relatable format.

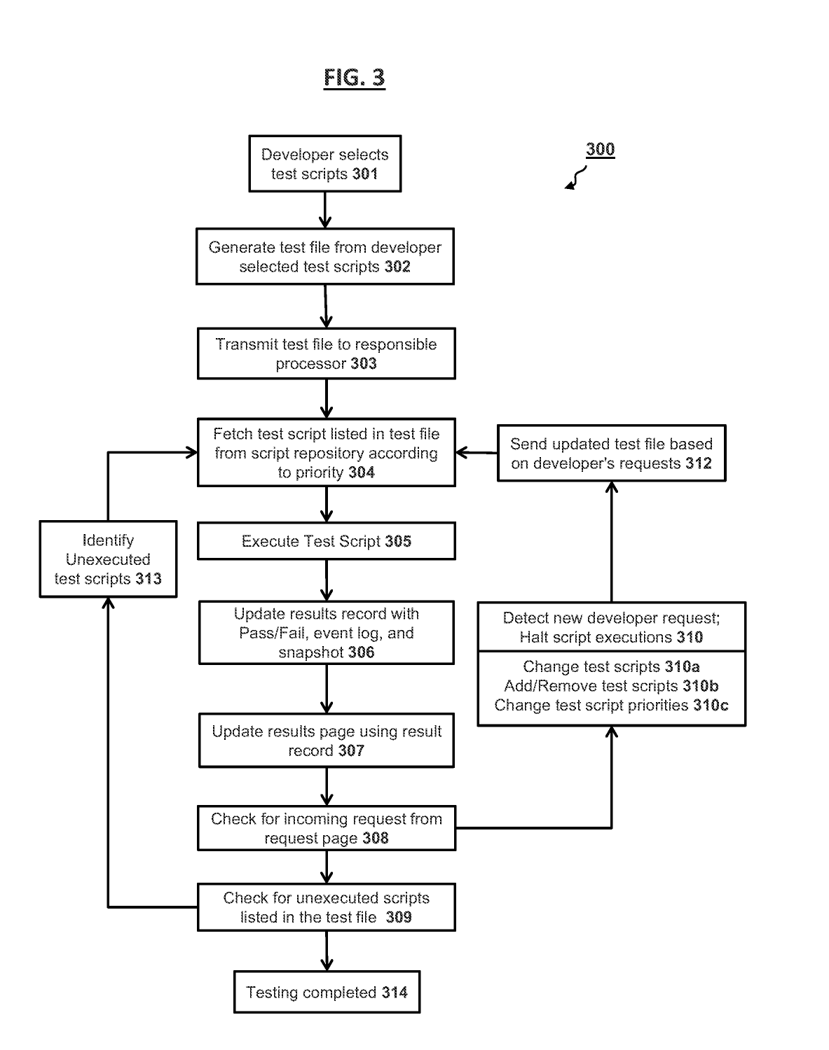

FIG. 3 shows a flowchart of the logical steps performed by an exemplary method embodiment, in accordance with various systems, processes, software modules, and hardware as described herein.

In a first step 301, a developer triggers the exemplary process 300 by selecting one or more test scripts for execution. Executing the selected test scripts may test the functionality of portions of code in a software product that is under development. The developer may select the test scripts using a developer user interface (“developer UI”), The developer UI may be the product of a software module reside on the physical computing device executing the test scripts. The software modules underlying the developer UI may reside on a distinct physical computing device from the physical device executing the test scripts.

In a next step 302, a test file is generated to include information identifying the developer's selected test scripts. The selected test scripts are stored in a script repository. Test scripts stored in the script repository may be associated with a unique test script identifier. As such, the test file may include a listing of each of the test script identifiers associated with the selected test scripts. In some embodiments, generating a test file may include adding each of the unique test script identifiers that are associated with each of the developer's selected test scripts. In some embodiments, the test file may also include a listing of priorities for each test script, which may used for determining the order in which selected test scripts are retrieved and executed.

In a next step 303, the test file may be transmitted to a processor designated to fetch and execute test scripts. The test file may be generated by a first processor and then transmitted to a second processor. The second processor may fetch test scripts listed in the test file, and then execute the test files. It should be appreciated that in some embodiments, the step 303 may not occur since the processor generating the test file may also execute the test scripts. It should also be appreciated that there may be one or more processors designated to fetch test scripts, execute test scripts, or both.

In a next step 304, a computer executing test scripts may receive a test file from a server generating test files according to inputs from a developer UI. Using the test file, the computer may fetch a test script to execute from a script repository. The computer may determine the test script to fetch based on test script identifiers listed in the test file. Test script identifiers may uniquely correspond to test scripts stored in the script repository. In some embodiments, the test file may include a listing of execution priorities associated with each of the test scripts listed in the test file. The computer may fetch and execute test scripts according to the listing of priorities in the test file.

As mentioned above, in some embodiments assigned priority levels may be implemented for determining the order of executing test scripts. One or more priorities may not be explicitly defined by a developer. In some embodiments not assigning a specific priority to test scripts, a number of alternative methodologies may be employed for determining the order in which the computer may fetch test scripts. Examples of such methodologies for determining the order of fetching test scripts may include: randomized test script fetching, fetching the first test script listed in the test file (first-in-first-out), fetching the first test script in the script repository, fetching the most accessible test script stored in the script repository, fetching the last test script listed in the test file (last-in-first-out), fetching the last test script in the script repository, fetching the least accessible test script in the script repository, among others.

In a next step 305, the computer may execute the test script fetched from the test script repository. The computer may monitor the execution of the test script, which may be executed using a framework software module for building and testing software code, such as a. software development kit (SDK), and/or an integrated development environment (IDE), among others. The framework module may be capable of testing code using test scripts and return the results. Script execution results may be a success, a fail, and an error. It should be appreciated that the manner such results are reported may vary, for example reporting the color green for a successful test script execution. The result of a test script may be stored into a non-transitory machine-readable storage medium, such as a computer file or memory.

In some embodiments, the computer monitoring the test script execution may generate an event log containing information describing the execution of the test script. After determining that the test script has produced an unsuccessful result for a functionality test, the computer may capture a visual screenshot of the developer UI. The screenshot may capture a still image of an interface of the developer UI that shows real-time information relating to the script execution. When the test script produces the failed result, the screenshot is produced by capturing a still image of the real-time information display when the test script fails, thereby capturing the visual information display for developer review. The results produced by the computer for a test script may comprise an execution result, an event log, and screenshot.

In a next step 306, a results record may be updated according to a result of an executed test script. In some embodiments, a server may update the results record according to a result received from a computer that executed the test script. The computer may update the results record stored in a memory of the computer or another computing device. In some embodiments, results record may be updated after each test script listed in the test file is executed. The results record may be periodically updated, after a number of test scripts are executed. The results record may store a result for each test script. The results record of a test script may comprise a result status indicating the result of execution (e.g., pass, fail, error), an event log describing the execution of test script, and screenshot capturing a still image of a visual information display.

In a next step 307, a results page of a developer UI may be updated according to an updated results record. A results record underlies the results page such that the results record provides content for dynamically generating the results page for display. The developer may review the results page after the underlying results records are updated to assess the efficacy of the software code and the test scripts selected for testing.

In a next step 308, a computer may determine whether a developer has requested changes to the test script execution plans found in the existing test file. In some embodiments, a developer may request changes to the test script file while the computer is executing the test scripts. That is, the computer will continuously fetch and execute test scripts in a batch, in the order indicated by the test file. The user may request that the test file be changed before the computer completes the test file (i.e., executes each of the listed test scripts). In some embodiments, a developer may issue requests to change the test file using a developer UI. The computer may complete execution of a test script and then, before fetching the next test script, check whether a request for changes was received from the developer UI.

In a next step 310, the computer may detect a request to change the test script execution plans. in some embodiments, detecting the request redirects the computer's execution activity to address the particular action request. That is, test script execution halts while an updated test file is generated to reflect the requested changes to the test script execution plans. There may be any number of requests that may be received requiring an updated test file. There may also be any number of types of requests requiring an updated test file.

As an example 310a of a request prompting generation of an updated test file, the developer may request changes to the test scripts listed in the test file. Changing test scripts listed in the test file may ultimately have the effect of changing the test scripts that will be used for testing software code since the computer may fetch and execute those test scripts indicated by the test file. As another example 310b, the developer may request for an additional test script to be listed in the test file. In some cases, the developer may also request to remove a test script that is already listed in the test file. As another example 310c, the developer may request to change the priorities associated with the test scripts. In many cases, this may have the effect of altering the order in which the test scripts are fetched and executed by the computer.

In a next step 312 after detecting a request for changes to the test scripts to be executed, an updated test file reflecting the developer's requested changes must be generated and transmitted to computers fetching and executing the test scripts. In some embodiments, test files are generated by a device hosting a web server. It should be appreciated that any number of computing devices may be capable of producing test files according to commands from a developer UI. In some embodiments, the updated test file may be a new machine-readable file, which may be generated to overwrite the previously transmitted existing test file. In some embodiments, the existing test file may be updated to reflect the changes requested in the request received from the developer UI. As previously mentioned, in order to accommodate such changes to the existing test file, a computer executing test scripts according to the existing test file may halt execution, such that the computer is prohibited from fetching the next test script to be executed in the existing test file. Thus, the execution of test scripts is not affected when a developer requests changes to the test script plan.

According to step 312, the server, or other device generating test files, may transmit the updated test file to the computer to execute accordingly. Once the computer receives the updated test file, the computer is permitted to proceed with executing test scripts using the updated test file. The process may repeat from a previous step 304, in which the computer fetches a test script listed in the test file according to the priorities associated with the test scripts.

In a next step 309, a computer executing test scripts may determine whether there are any unexecuted test scripts listing in the test file. Test scripts listed by the test file are expected to be executed at least once. Test scripts should not run more than once. Embodiments of the computer may determine whether each test script listed in the test file has been retrieved and executed. The computer may identify each of the test scripts that have been executed based on a script identifier, or other identifying information, associated with each respective test script. The computer may then match such identifying information against results records, script results, or some other memory denoting scripts that have been executed.

In a next step 313, the computer may identify one or more test scripts that have not been executed yet. If the computer identifies an unexecuted test script listed in the test file, the process 300 may repeat at a previous step 304, in which the computer may fetch and execute the next test script to be executed, according to the test file. In some embodiments, the process 300 may repeat from previous step 304 until each test script listed in the test file is executed.

In a next step 314, the computer does not identify any unexecuted test scripts listed in the test file, and thus the testing is completed since the test file is now finished. After the process 300 is completed, the results records may be displayed in a human-related format for developer review using a developer UI. The results records may be presented on a results page of the developer UI. The results page may present the results records according to various settings predetermined by the developer. The results records may be queried in order to present various informative views of the information contained in the results records.

In Example 1, a developer selects test scripts to be executed using a developer user interface presented on an internal, private website. The user interface website comprises a results page displaying test script execution statuses (Pass/Fail), a log, and a screenshot, for completed test scripts. The user interface website also comprises a request page allowing the developer to submit a request for the system to accommodate changes to the test script execution plans, requiring the server hosting the website to produce an updated test file. The request may be changing execution priorities assigned to test scripts selected for execution, and selecting or deselecting the test script for execution.

Test script identifiers for selected test scripts are placed in a test sheet. The request page of the user interface has an input field prompting the developer to explicitly determine each test script's priority. Test script identifiers associated with these selections are then stored on the test sheet. The test sheet is transmitted to a driver computer where a driver program (e.g., framework, IDE, SDK) will read the test sheet to determine test scripts that need to be retrieved from the test script repository. The test file in Example 1 is a Microsoft Excel® spreadsheet, but file formats may be different for other embodiments, as discussed previously. The records in the test file comprise test script identifiers and a test script execution priority based on the developer's input at the request page. The driver program reads and loads the required test script from test repository.

The test script repository of Example 1 is a SQL-based database residing on a distinct device from webserver hosting the website. The test script repository stores each of the test scripts such that they are effectively retrieved based on each test script's unique identifier. The queue buffer memory is found locally, on the driver computer. Once the driver computer receives the test scripts, the driver computer triggers execution of test scripts based on priority mentioned in test sheet. In this example, each test script execution produces a status, log, and a snapshot whenever a test script status is a “fail.” The driver program is synchronized with a web service of the server hosting the website, allowing each of execution results to be updated in real-time and also allowing the test script execution plan (i.e., test file) to be continuously monitored for changes requests submitted from the developer. The driver program updates a test script's result after execution. In Example 1, the test script result is reported to the developer through a results page. The results page displays a spreadsheet comprising test script names, test script execution statuses, links to the log, and links for each snapshot.

Prior to fetching and executing each successive test script, the driver program will check if there is an action request from the web server that requires handling. If there is no action request, then the driver program proceeds to execute the next test script. However, if there is an action request, then the driver program proceeds according to the action request; for example, if there are changes to test script priority, then the driver program proceeds to update the test sheet and executes the remaining test scripts in the test sheet according to the new priority requirements. The driver program repeats, sequentially fetching and executing test scripts based on the test sheet until there are no more test scripts in test sheet left to execute.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention, Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer implemented method for executing test scripts comprising:
receiving, by a computer, from a server a test file comprising a set of one or more unique test script identifiers, wherein each of the test script identifiers are associated with a test script stored in a test script repository;
fetching, by the computer, a test script from the test script repository according to the test file;
storing, by the computer, the test script as a queued test script in a buffer memory;
updating, by the computer, a test script result record based on a result of executing the test script, wherein the result comprises a test script status indicating a pass when the queued test script is successfully executed and a fail when the queued test script is unsuccessfully executed;
continuously monitoring, by the computer, an action request queue configured to receive and store one or more action requests indicating one or more changes to be made to the test file;
responsive to identifying an action request in the action request queue:
pausing, by the computer, execution of the set of test scripts in the test file until receiving an updated test file having the one or more changes of the request; and
upon receiving the updated test file:
updating, by the computer, the test script result record based on the result of executing a next test script in the test file.

2. The method according to claim 1, further comprising:
transmitting, by the computer, the test script to a second computer;
providing, by the computer, instructions to execute the queued test script; and
receiving, by the computer, the result of executing the test script from the second computer, wherein the computer updates the test script result record based on the result.

3. The method according to claim 1, wherein the action request indicates a change to a test script in the set of test scripts in the test file.

4. The method according to claim 1, wherein each of the test scripts in the test file is associated with a priority indicating an order for the computer to fetch each test script.

5. The method according to claim 4, wherein the action request indicates a change to the respective priority of one or more test scripts in the test file.

6. The method according to claim 1, further comprising determining, by the computer, whether each of the test scripts in the test file have been fetched from the script repository and executed; and

[symbol]

7. The method according to claim 6, further comprising, fetching, by the computer, a next test script according to the test file responsive to determining that each test script in the test file has not been executed.

8. The method according to claim 1, further comprising, updating, by the computer, an event tog containing information describing executing the test script, wherein the test script result record further comprises the event log.

9. The method according to claim 8, presenting, by the computer, a results page of a user interface displaying one or more results records corresponding to one or more test scripts, wherein the results records comprise the respective result status and event log for the one or more test scripts corresponding to the results records.

10. The method according to claim 9, further comprising:
generating, by the computer, a real-time display for output to the user interface displaying information related to the test script during execution; and
responsive to determining a fail status for the test script:
capturing, by the computer, a screenshot containing the display for the user interface, wherein the results records of the results page further comprises the screenshot.

11. The method according to claim 1, wherein the action request indicates a change to a test script identifier for one or more test scripts.

12. A software development system comprising:
a test script repository storing one or more test scripts, wherein each test script is associated with a unique test script identifier;
a test file storing a set of test script identifiers, wherein each of the test script identifiers is associated with a test script priority;
a driver computer comprising a processor configured to:
fetch a queued test script from the test script repository using the test file, and then store the queued test script into a buffer memory;
execute the queued test script and generate a test script result having a test script status, and then transmit the test script result to a web server;
execute an action request to the web server when an action request is detected in an action request queue before fetching a next queued test script; and
the web server comprising the action request queue and a web server processor, wherein the web server processor is configured to:
generate the test file according to a request page, update the test file according to an action request, update a results page comprising one or more test script results in a human-readable format, and transmit action requests to the driver computer.

13. The system according to claim 12, wherein the driver computer processor fetches a next test script to be executed according to the test file.

14. The system according to claim 13, wherein the driver computer determines whether each of the test scripts in the test file have been fetched and executed.

15. The system according to claim 12, wherein the test script result record further comprises an event log, and wherein the web server processor is further configured to update the results page to include the results log.

16. The method according to claim 13, wherein the driver processor is further configured to receive a snapshot of a test script allure and the test script result record further comprises a snapshot when the test script status is a failure; the web server processor further configured to update the results page with the snapshot when the test script is a failure.

17. The system according to claim 12, wherein the test file further comprises a set of priorities indicating an ordering for executing by the driver processor each of the test scripts in the test file, wherein each test script identifier is associated a priority.

18. The method according to claim 17, wherein an action request, in the action request queue, is a change to a test script in the script repository, and wherein the change to the test script is a script reprioritization, or a test script identifier change.
